(19) United States
(12) Patent Application Publication
(10) Pub. No.: US 2026/0086824 A1
(43) Pub. Date: Mar. 26, 2026

(54) SYSTEM AND METHOD FOR LOADING A DRIVER INTO AN OPERATING SYSTEM

(71) Applicant: AO Kaspersky Lab, Moscow (RU)

(72) Inventors: Maxim O. Elchugin, Moscow (RU); Egor E. Vedyashkin, Moscow (RU); Semen A. Andreev, Moscow (RU); Vladislav V. Pintiysky, Moscow (RU)

(21) Appl. No.: 19/212,780

(22) Filed: May 20, 2025

(30) Foreign Application Priority Data
Sep. 25, 2024 (RU) 2024128370

(51) Int. Cl. G06F 9/445

(52) U.S. Cl. CPC G06F 9/44521

(57) ABSTRACT

Disclosed are systems and methods for loading an operating system (OS) driver. An example method comprises: receiving, by a server, at least one version of the OS kernel; compiling the driver for each version of the OS kernel; generating a driver template by removing from at least one compiled driver information necessary to load said compiled driver into an OS; generating a configuration file that includes necessary information to load the driver on at least one version of the OS kernel, wherein the necessary information is extracted from the compiled drivers; and transmitting, by the server, the driver template and the configuration file to a OS of the client which assembles a resulting driver from the driver template and the configuration file and loads at least one resulting driver into the OS of the client.

### CROSS REFERENCE TO RELATED APPLICATIONS

The present application claims benefit of claims priority to Russian Patent Application No. 2024128370, filed on Sep. 25, 2024, which is incorporated herein by reference.

### FIELD OF TECHNOLOGY

The present invention relates to the field of information technology, and more specifically to systems and methods for loading a driver into an operating system.

### BACKGROUND

The number of computer threats arising from various malicious applications (malware), such as, network worms, viruses, Trojan horses, as well as computer attacks by cybercriminals is continuously growing. And, most computer devices, regardless of hardware and software, are susceptible to these threats. Often, modern security systems are implemented at the level of the operating system (OS) of the device. Such security system includes components for analyzing the activity of processes in the OS.

A process is an executable instance of a program. In most OS, there are two main modes of process operation: kernel mode and user mode. In the kernel mode, a process has unlimited access to system resources, but instability in kernel mode can cause the entire computer system to crash. In the user mode, a process has limited access to system resources and cannot perform privileged operations. Unlike kernel-mode process operation, user-mode process instability has no impact on the OS kernel, so the risk of affecting OS stability is much lower.

To detect malicious activity in the Linux operating system, behavior detection components use various mechanisms to gather information about process activity. These components can be implemented at both the kernel level and the user level. Process behavior detection components are often part of antivirus software, such as Kaspersky Endpoint Security for Linux (KESL).

Protection against information security threats in Linux with the help of solutions implemented at the kernel level is achieved through the use of various mechanisms, such as: interception of system calls, shielding of asynchronous notifications of the process about events (shielding of kernel signals), prevention of the execution of malware, including programs capable of hiding processes and escalating privileges, and others.

In Linux OS, there is a feature that in an OS with a certain version of the kernel, one can run only the driver that was compiled for this version of the OS kernel. Due to this feature, components implemented at the kernel level require more time and expertise to adapt to different versions of the kernel. Such components may include components based on Berkley Packet Filter (BPF).

BPF is a virtual machine in the Linux kernel designed to execute software compiled on a specific version of the OS kernel when a predetermined event is triggered. The disadvantages of this system include the need to compile the specified software on each computer system on which this software will be used, as well as the support of the BPF functionality by the OS kernel, starting from version 5.7. Such solutions have another significant drawback—the lack of the ability to continuously ensure OS security. Due to this Linux feature, when the kernel version changes, the driver will not start, and the OS will subsequently be unprotected until a driver compiled for the modified version of the OS kernel is delivered to it.

Thus, there is a need to develop a solution that allows the driver to be loaded into an OS with different kernel versions.

### SUMMARY

The present invention is intended to adapt a driver to specific versions of the OS kernel for subsequent detection of malicious activity in the OS with the corresponding kernel version. The adaptation involves assembling a driver for a specific OS kernel based on a driver template and then loading it into the OS with the corresponding kernel version. The task to be solved by the present invention is to develop a method and system for loading a driver into the OS. In particular, this system and method can be used to load a driver into the OS designed to control process calls in the OS, which in turn will increase the flexibility and adaptability of solutions aimed at protecting the OS from information security threats.

The technical result of the present invention is the expansion of the arsenal of technical means designed to protect the operating system from information security threats, namely, in a solution that allows loading a driver for each installed version of the OS kernel. An additional result is to ensure continuous protection of the OS of the client from information security threats when changing the OS kernel version by assembling and loading the resulting driver for each installed version of the client's OS kernel.

In one example aspect, a method for loading an OS driver comprises: receiving, by a server, at least one version of the OS kernel; compiling the driver for each version of the OS kernel; generating a driver template by removing from at least one compiled driver information necessary to load said compiled resulting driver into an OS; generating a configuration file that includes necessary information to load the resulting driver on at least one version of the OS kernel, wherein the necessary information is extracted from the compiled drivers; transmitting, by the server, the driver template and the configuration file to a client; determining at least one version of the OS kernel installed on the client; assembling the resulting driver for each determined version of the OS kernel installed on the client based on the configuration file and the driver template; and loading at least one resulting driver into the OS of the client.

In one aspect, the necessary information includes least one of: a line from the “modinfo” section starting with “vermagic=”; information from the “version” section; information from the “this_module” section.

In one aspect, the necessary information further includes at least one of: information about the offset of the address of the kallsyms_lookup_name symbol relative to the kmalloc symbol; information from the “modinfo” section; information from the section with OS kernel constants; information from the section with symbols of the OS kernel; information from the section with driver functions.

In one aspect, the generated configuration file comprises all section versions, as well as for each kernel version, comprises the following information: information from the “modinfo” section starting with “vermagic=”; and Section IDs.

In one aspect, the generated configuration file further comprises information about the offset of the address of the kallsyms_lookup_name symbol relative to the kmalloc symbol.

In one aspect, the configuration file is generated containing the necessary information for loading the resulting driver into the OS with any downloaded version of the OS kernel.

In one aspect, the configuration file is generated for a determined set of versions of the OS kernel.

In one aspect, the resulting driver is configured to control process calls in the OS in order to protect the client OS from information security threats.

In one example aspect, a system for loading an OS driver, comprising: a hardware processor configured to: receive at least one version of the OS kernel; compile the driver for each version of the OS kernel; generate a driver template by removing from at least one compiled driver information necessary to load said compiled driver into an OS; generate a configuration file that includes necessary information to load the resulting driver on at least one version of the OS kernel, wherein the necessary information is extracted from the compiled drivers; transmit the driver template and the configuration file to a client; determining at least one version of the OS kernel installed on the client; assemble the resulting driver for each determined version of the OS kernel installed on the client based on the configuration file and the driver template; and load at least one resulting driver into the OS of the client.

In another example aspect, a non-transitory computer readable medium storing thereon computer executable instructions for loading an OS driver, including instructions for: receiving, by a server, at least one version of the OS kernel; compiling the driver for each version of the OS kernel; generating a driver template by removing from at least one compiled driver information necessary to load said compiled driver into an OS; generating a configuration file that includes necessary information to load the resulting driver on at least one version of the OS kernel, wherein the necessary information is extracted from the compiled drivers; and transmitting, by the server, the driver template and the configuration file to a client; determining at least one version of the OS kernel installed on the client; assembling the resulting driver for each determined version of the OS kernel installed on the client based on the configuration file and the driver template; and loading at least one resulting driver into the OS of the client.

### BRIEF DESCRIPTION OF DRAWINGS

The accompanying drawings, which are incorporated into and constitute a part of this specification, illustrate one or more example aspects of the present disclosure and, together with the detailed description, serve to explain their principles and implementations.

FIG. 1 illustrates an example of a computer network that implements a system for loading a driver into an operating system.

FIG. 2 illustrates an example of information about a Linux OS kernel module.

FIG. 3 illustrates a first example of a method for loading drivers into an OS.

FIG. 4 illustrates a second example of a method for loading drivers into an OS.

FIG. 5 illustrates a general-purpose computer system on which variant aspects of system and methods disclosed herein may be implemented.

### DETAILED DESCRIPTION

Exemplary aspects are described herein in the context of a system, method, and computer program product for loading a driver into an operating system. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

In the Linux OS, there are two main modes of process operation: kernel mode and user mode. Often, components designed to analyze the activity of processes and aimed at protecting the OS of a computer system from information security threats use a driver in their work. Processes generated by the driver run in kernel mode and have unrestricted access to computer system resources, such as CPU time, memory, I/O devices, and other resources. Typically, such a driver is loaded according to the Linux kernel version. However, if the kernel version is changed, the driver will not be able to be loaded due to the Linux feature that restricts loading of a driver compiled for another kernel version into an OS with one version of the OS kernel. Therefore, in order to resume Linux protection against information security threats, one needs to load a driver compiled for a modified version of the OS kernel. Storing drivers for all versions of the OS kernel on a computer system solves the problem of continuous protection, but this approach requires a significant amount of permanent memory allocated for these drivers.

The invention disclosed herein solves the problem of continuous protection of the operating system and at the same time requires a smaller amount of allocated permanent memory compared to storing drivers of all versions of the OS kernel.

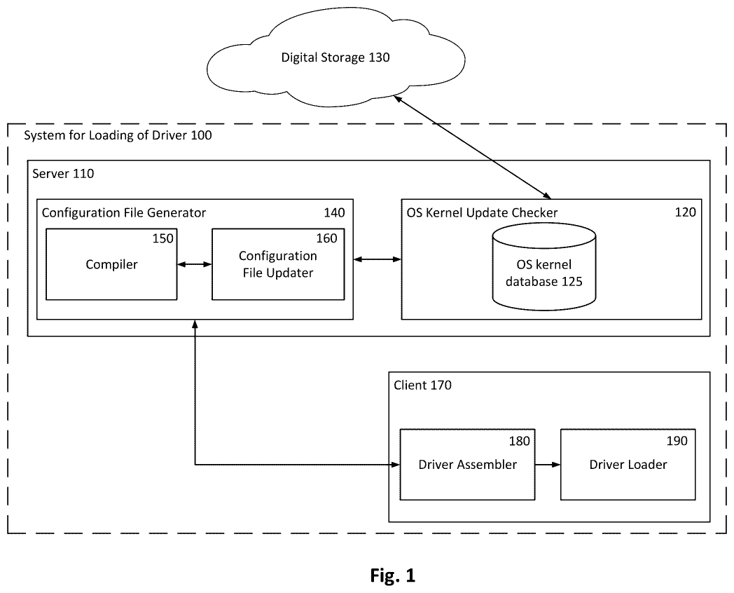

FIG. 1 illustrates an example of a computer network that implements a system for loading a driver into the OS (i.e., system 100).

In one aspect, system 100 loads a resulting driver into OS of computer system 170 (i.e., client 170). The resulting driver is configured to control process calls to the OS in order to protect OS of the client 170 from information security threats. For example, the resulting driver can prevent a kill call from being executed against the antivirus process.

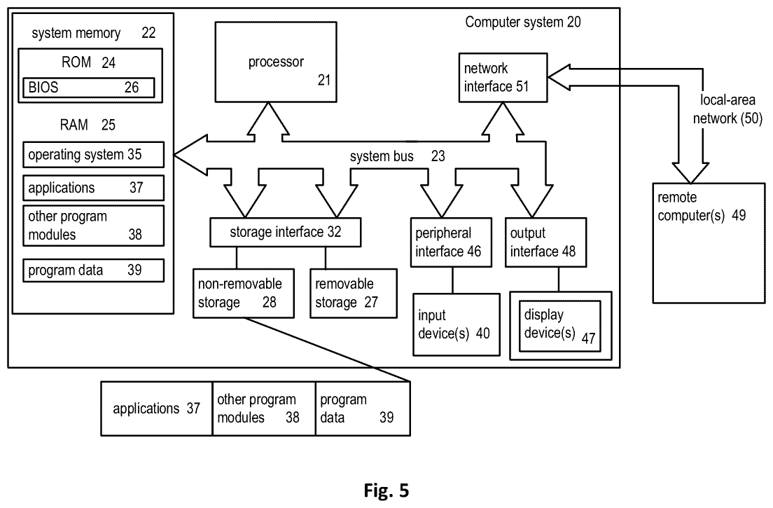

System 100 assembles the driver based on the driver template and the necessary information from the configuration file and then uploads it to the OS Linux of the client 170. In one aspect, system 100 may be a distributed system, e.g., implemented on server 110 and client 170. System 100 may be implemented using a single computer system, an example of which is shown in FIG. 5.

For the purposes of the description, a driver template is a compiled driver whose binary code lacks the necessary information to load into the OS. For example, the configuration file generator 140 may also generate the driver template by removing the necessary information for loading of the driver from the binary code of the compiled driver.

The operation of the system 100 can be conventionally divided into two stages—the stage of generating the configuration file and the stage of assembling the resulting driver. In one aspect, when the system 100 is a distributed system, the step of generating the configuration file is carried out using server 110, and the stage of assembling the resulting driver is carried out using the client 170.

### The Stage of Generating a Configuration File

Server 110 includes an OS kernel update checker 120 and a configuration file generator 140.

In one aspect, the OS kernel update checker 120 includes an OS kernel database 125 and is designed for: checking the publication of new versions of the OS kernel in digital storage 130 at a predetermined frequency; and receiving new versions of the OS kernel from the digital storage 130.

A new version of the OS kernel refers to any version of the OS kernel that is not contained in the OS kernel database 125.

Digital storage 130 is designed to store at least one version of the OS kernel.

In one aspect, the digital storage 130 is located on the global Internet and is a Linux kernel repository or a Linux distribution repository. Examples of a Linux OS distribution repositories include Fedora and Ubuntu repositories.

In another aspect, digital storage 130 is located on a local network. In this case, the repository may be located either on server 110 or on a separate device that is a digital information store.

The OS kernel update checker 120 checks at predetermined intervals to see if new versions of the OS kernel have been published in the digital storage 130. If a new version of the OS kernel is determined, the OS kernel update checker 120 downloads the determined version of the OS kernel from the digital storage 130 to the server 110, namely to the OS kernel database 125.

After downloading new versions of the OS kernel from the digital storage 130, the OS kernel update checker 120 transfers all downloaded versions of the OS kernels from the OS kernel database 125 to the configuration file generator 140.

In one aspect, in case the digital storage is located on server 110, system 100 does not contain an OS kernel update checker 120. In which case, the configuration file generator 140 retrieves versions of the OS kernel from the digital storage 130.

The configuration file generator 140 is designed to create a configuration file from a driver compiled for different versions of the OS kernels. The configuration file generator 140 contains a compiler 150 and a configuration file updater 160.

Compiler 150 is designed to compile a driver for different versions of OS kernels. Compilation—is the process of translating program code written in a high-level programming language into binary code that can be executed by a computer.

The compiler 150 compiles the driver for each downloaded version of the OS kernel, and then transmits the compiled driver to the configuration file updater 160.

The configuration file updater 160 is designed to extract the information from the compiled drivers necessary to load the resulting driver into a determined version of the OS kernel and to create a configuration file based on the extracted information. Thus, the configuration file contains the necessary information to load the resulting driver into the OS with the kernel versions that the extracted information from the compiled drivers corresponds to. It should be noted that if a configuration file has already been created, then the necessary information from the compiled drivers for new versions of the OS kernel is added to it.

In one aspect, the generated configuration file contains the necessary information to load the resulting driver into the OS with any downloaded version of the OS kernel.

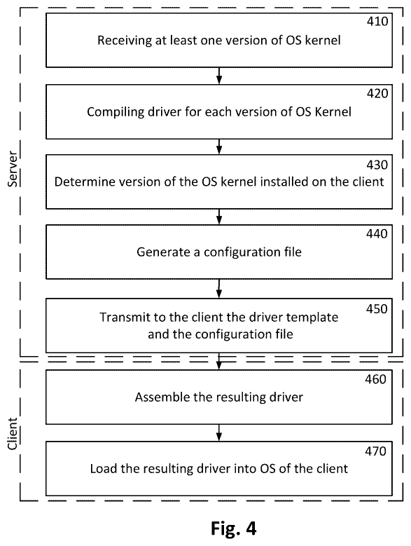

In one aspect, the configuration file contains the necessary information to load the resulting driver into an OS with predefined versions of the OS kernel. An example of the use of such a configuration file is provided in FIG. 4.

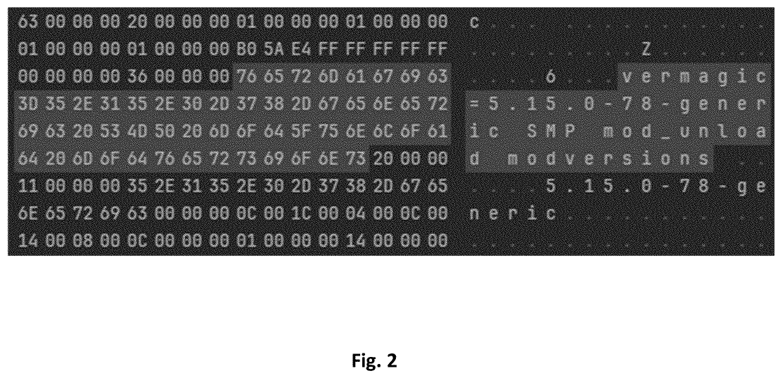

The information required to load the resulting driver into the OS from a determined kernel version includes at least the following information from the compiled driver: driver information retrieved from the “modinfo” section, with the necessary information beginning with the “vermagic=” part (an example of information is shown in FIG. 2); information from the “version” section; and information from the “this_module” section.

In one aspect, the specified necessary information includes information from the entire “modinfo” section.

In yet another aspect, this required information is further provided by at least the following information from the compiled driver: offset of the address of the kallsyms_lookup_name symbol relative to the kmalloc symbol; information from the section with the OS kernel constants used by the driver; information from the section with the OS kernel symbols used by the driver; and information from the section with driver functions.

The information in the line from the “modinfo” section, starting with “vermagic=”, contains the version of the OS kernel for which the driver was compiled. The driver will not be able to run on an OS with a different version than the one specified in “vermagic=”.

The information in the “version” section contains the Cyclic Redundancy Check (CRC) values of the OS kernel symbols required for the driver to work. Required symbols include at least the module_layout symbol, which defines the driver structure for a particular OS kernel, and the kmalloc symbol.

The information in section “this_module” contains the module structure that is used by the kernel to manage this driver. This structure provides the kernel with the information it needs to effectively manage the driver's lifecycle, including loading, unloading, and initializing the driver.

The information from the section with the OS kernel constants used by the driver contains the values of the OS kernel constants, which may differ in different versions of the OS kernel. For example, let's consider the TASK_WAKEKILL constant. In the Linux OS kernel version 3.10, this constant has a value of 0x80, and in the Linux OS kernel version 5.15, this constant has a value of 0x100. Thus, depending on the version of the OS kernel, the configuration file updater 160 will add to the configuration file the value of the TASK_WAKEKILL constant corresponding to the version of the OS kernel.

The information from the OS kernel constants section also contains information about offsets from the address of system structures to the address of the required fields of system structures. These offsets are also necessary for the operation of the driver, as they may differ depending on the version of the OS kernel. For example, let's take a look at the TaskStruct system structure, which contains a process id (pid) field. This structure describes information about processes and their threads. In order for the loadable driver to retrieve information from the process ID field of the TaskStruct structure, it needs to know the offset of the address of the process ID field relative to the TaskStruct address. Thus, the configuration file updater 160 will add to the configuration file an offset of the address of the process identifier field relative to the TaskStruct address.

The information in the section with the OS kernel symbols used by the driver contains the OS kernel symbols, which, like the OS kernel constants, may differ depending on the version of the OS kernel. The configuration file updater 160 adds the OS kernel symbols used in the driver code to the configuration file.

For example, if the driver is designed to control calls to processes in the OS in order to protect the OS of the client from information security threats, then one of the driver's functions can be aimed at collecting information about the process in the OS or controlling the execution of system calls by the process (for example, terminating another process by using the kill system call). The configuration file updater 160 may place all or part of the compiled functions in the configuration file. The composition or versions of the functions may vary depending on the version of the OS kernel.

In one aspect, each section is represented in the configuration file in at least one version. The configuration file updater 160 assigns an identifier to each version of each section. Within a single section, the configuration file updater 160 assigns unique identifiers to the different versions. In this aspect, the configuration file contains all versions of the sections. For each version of the OS kernel, the configuration file contains at least the following information: a line from the “modinfo” section starting with “vermagic=”; and Section IDs.

In one aspect, for each version of the OS kernel, the configuration file additionally contains information about the offset of the address of the kallsyms_lookup_name symbol relative to the kmalloc symbol.

This implementation minimizes the size of the configuration file, which in turn has a positive effect on the speed of transferring the configuration file to client 170, as well as on the amount of permanent memory allocated for storing the configuration file on client 170.

To better understand how to implement a configuration file using section identifiers, let's look at an example. There are two sets of versions of the OS kernel and two versions of the section with constants. In total, there are twenty versions of the OS kernel in the two sets. The first set of versions of the OS kernel corresponds to a section with constants with the identifier “1”, and the second set of versions of the OS kernel corresponds to a section with constants with the identifier “2”. The configuration file contains both sections in a single instance. For each version of the OS kernel, the partition ID is stored in the configuration file. Thus, instead of twenty sections with OS kernel constants, only two sections with OS kernel constants are stored in the configuration file, which in turn has a positive effect on the size of the configuration file.

### The Stage of Assembling the Resulting Driver

When configuration file is generated, the configuration file generator 140 transfers the generated configuration file and driver template to the client 170, namely to the driver assembler 180.

The driver assembler 180 is designed to build the resulting driver based on the driver template and the required information from the configuration file.

Resulting driver—a driver built to be loaded into an OS with a determined version of the OS kernel from a driver template and the required information corresponding to the version of the OS kernel on client 170 from a configuration file.

Driver assembler 180 determine at least one version of the OS kernel installed on the client 170 and assembles the resulting driver for at least one determined version of the OS kernel by adding the necessary information from the configuration file to the driver template. To do so, driver assembler 180 first determines the version of the OS kernel installed on the client 170 by reading the /boot directory located in the OS of the client 170. Next, the driver assembler 180 adds all the necessary information from the configuration file to the binary code of the driver template corresponding to a determined version of the OS kernel.

In one aspect, the driver assembler 180, before adding the necessary information from the configuration file to the driver template, receives the address of the kmalloc symbol from a certain version of the OS kernel, adds to it the offset value of the kallsyms_lookup_name symbol relative to the kmalloc symbol for a certain version of the OS kernel from the configuration file, and transmits the resulting address of the kallsyms_lookup_name symbol to the driver template. Thus, the resulting driver will have access to the symbol kallsyms_lookup_name a determined version of the OS kernel, which in turn will allow it to access other symbols of a determined version of the OS kernel.

The driver assembler 180 transmits the resulting driver for at least one version of the OS kernel installed on the client 170 to the driver loader 190, which in turn loads the resulting driver into the OS of the client 170.

It should be noted that by loading the resulting drivers into the OS of the client 170 for all determined versions of the OS kernel of the client's 170, the continuity of the driver's functions is achieved. If the driver is designed to ensure the security the OS of the client 170 by controlling the execution of functions, then the continuity the OS of the client protection from information security threats is additionally achieved.

In one aspect, the configuration file generator 140 receives from the driver assembler 180 the versions of the OS kernel installed on the client 170. The configuration file generator 140 generates a configuration file that includes only the necessary information to load the resulting driver on the versions of the OS kernel received from the driver assembler 180.

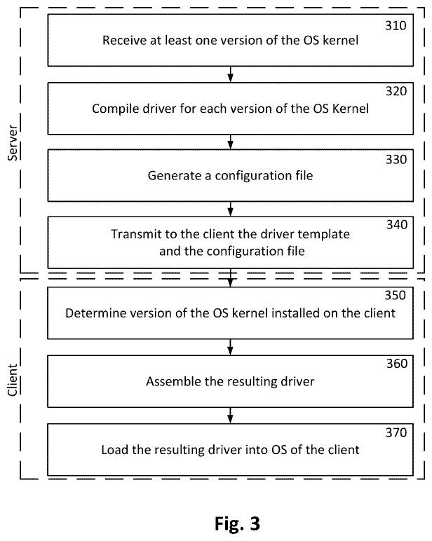

FIG. 3 illustrates a first example of how to load a driver into a Linux OS. The steps of the method can be roughly divided into two stages: the stage of generating a configuration file and the stage of assembling the resulting driver. In one aspect, the configuration file generation stage may be implemented on server 110, and the resulting driver assembly stage may be implemented on client 170.

### The Stage of Generating a Configuration File

At step 310, the OS kernel update checker 120 downloads at least one version of the OS kernel from the digital storage 130 and stores the resulting versions of the OS kernels in the OS kernel database 125.

### In Step 320, the Driver Is Compiled for Each Downloaded

version of the OS kernel.

At step 330, a configuration file is created that includes the necessary information to load the resulting driver into an OS with a particular kernel version, and this information is extracted from the drivers compiled in step 320. Required information includes at least the following information from the compiled driver: driver information obtained from the “modinfo” section, with the required information starting with the “vermagic=” part; information from the “version” section; information from the “this_module” section. The configuration file contains the necessary information to load the resulting driver into the OS with the kernel versions for which the extracted information from the compiled drivers corresponds. It is worth noting that if the configuration file has already been created, then new or additional necessary information is added to it.

In step 340, the driver template and the generated configuration file are transmited to the client 170.

### The Stage of Assembling the Resulting Driver

In step 350, determine at least one version of the OS kernel installed on the client 170 by reading the /boot directory located in the OS of the client 170.

In step 360, based on the configuration file and the driver template, assemble the resulting driver for each determined version of the OS kernel of the client 170 by adding all necessary information from the configuration file corresponding to the determined version of the OS kernel to the driver template binary.

In step 370, load all assembled (resulting) drivers into the OS of the client 170.

FIG. 4 illustrates a second example of a method for loading drivers into a Linux OS. The difference from the method disclosed in FIG. 3 is the timing of the determining version of the OS kernel installed on the client 170, as well as the contents of the configuration file. In the first example, the configuration file contains the necessary information to load the resulting driver into the OS with all version of the OS kernel from the OS kernel database 125. In the second example, all versions of the OS kernel installed on client 170 are first determined, and then a configuration file is generated for client 170 containing the necessary information to load the resulting driver into the OS with all versions of the OS kernel installed on client 170.

The steps of the method can be roughly divided into two stages: the stage of forming a configuration file and the stage of assembling the resulting driver.

The configuration file generation stage is implemented on server 110, and the resulting driver assembly stage is implemented on client 170.

### The Stage of Generating a Configuration File

At step 410, the OS kernel update checker 120 downloads at least one version of the OS kernel from the digital storage 130 and stores the resulting versions of the OS kernels in the OS kernel database 125.

### Step 420 Compiles the Driver for Each Downloaded Version of the OS kernel.

At step 430, determine at least one version of the OS kernel installed on the client 170 by reading the /boot directory located in the OS of the client 170.

In step 440, a configuration file is created that includes the necessary information to load the resulting driver into an operating system with a determined version of the OS kernel, and this information is extracted from the drivers compiled in step 420. Required information is understood to include at least one of the following information from the compiled driver: driver information obtained from the “modinfo” section, with the required information starting with the “vermagic=” part; information from the “version” section; information from the “this_module” section. The configuration file contains the necessary information to load the resulting driver into the OS with the kernel versions for which the extracted information from the compiled drivers corresponds. It is worth noting that if the configuration file has already been created, then new or additional necessary information is added to it.

In step 450, the driver template and the generated configuration file are transmitted to the client 170.

### The Stage of Assembling the Resulting Driver

In step 460, based on the configuration file and the driver template, assemble the resulting driver for each determined version of the OS kernel on the client 170 by adding all necessary information from the configuration file corresponding to the determined version of the OS kernel to the driver template binary code.

In step 470, load all assembled (resulting) drivers into the client 170 OS.

FIG. 5 shows an example of a computer system 20 on which variant aspects of systems and methods disclosed herein may be implemented. The computer system 20 may represent the server 110 and/or client 170 of FIG. 1 and can be in the form of multiple computing devices, or in the form of a single computing device, for example, a desktop computer, a notebook computer, a laptop computer, a mobile computing device, a smart phone, a tablet computer, a server, a cloud server, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 300.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 300 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for loading an operating system (OS) driver, comprising:
receive, by a server, at least one version of the OS kernel;
compiling the driver for each version of the OS kernel;
generating a driver template by removing from at least one compiled driver information necessary to load said compiled driver into an OS;
generating a configuration file that includes necessary information to load the resulting driver on at least one version of the OS kernel, wherein the necessary information is extracted from the compiled drivers; and
transmitting, by the server, the driver template and the configuration file to a client;
determining at least one version of the OS kernel installed on the client;
assembling the resulting driver for each determined version of the OS kernel installed on the client based on the configuration file and the driver template; and
loading at least one resulting driver into the OS of the client.

2. The method of claim 1, wherein the necessary information includes least one of:
a line from the “modinfo” section starting with “vermagic=”;
information from the “version” section;
information from the “this_module” section.

3. The method of claim 2, wherein the necessary information includes at least one of:
information about the offset of the address of the kallsyms_lookup_name symbol relative to the kmalloc symbol;
information from the “modinfo” section;
information from the section with OS kernel constants;
information from the section with symbols of the OS kernel;
information from the section with driver functions.

4. The method of claim 1, wherein the generated configuration file comprises all section versions, as well as for each kernel version, comprises the following information:
information from the “modinfo” section starting with “vermagic=”;
section IDs.

5. The method of claim 4, wherein the generated configuration file further comprises information about the offset of the address of the kallsyms_lookup_name symbol relative to the kmalloc symbol.

6. The method of claim 1, wherein the configuration file is generated containing the necessary information for loading the resulting driver into the OS with any downloaded version of the OS kernel.

7. The method of claim 1, wherein the configuration file is generated for a determined set of versions of the OS kernel.

8. The method of claim 1, wherein the resulting driver is configured to control process calls in the OS in order to protect the client OS from information security threats.

9. A system for loading an operating system (OS) driver, comprising:
one or more hardware processors configured to:
receive at least one version of the OS kernel;
compile the resulting driver for each version of the OS kernel;
generate a driver template by removing from at least one compiled driver information necessary to load said compiled driver into an OS;
generate a configuration file that includes necessary information to load the driver on at least one version of the OS kernel, wherein the necessary information is extracted from the compiled drivers; and
transmit the driver template and the configuration file to a client;
determine at least one version of the OS kernel installed on the client;
assemble the resulting driver for each determined version of the OS kernel installed on the client based on the configuration file and the driver template; and
load at least one resulting driver into the OS of the client.

10. The system of claim 9, wherein the necessary information includes least one of:
a line from the “modinfo” section starting with “vermagic=”;
information from the “version” section;
information from the “this_module” section.

11. The system of claim 10, wherein the necessary information includes at least one of:
information about the offset of the address of the kallsyms_lookup_name symbol relative to the kmalloc symbol;
information from the “modinfo” section;
information from the section with OS kernel constants;
information from the section with symbols of the OS kernel;
information from the section with driver functions.

12. The system of claim 9, wherein the generated configuration file comprises all section versions, as well as for each kernel version, comprises the following information:
information from the “modinfo” section starting with “vermagic=”;
section IDs.

13. The system of claim 12, wherein the generated configuration file further comprises information about the offset of the address of the kallsyms_lookup_name symbol relative to the kmalloc symbol.

14. The system of claim 9, wherein the configuration file is generated containing the necessary information for loading the resulting driver into the OS with any downloaded version of the OS kernel.

15. The system of claim 9, wherein the configuration file is generated for a determined set of versions of the OS kernel.

16. The system of claim 9, wherein the resulting driver is configured to control process calls in the OS in order to protect the client OS from information security threats.

17. A non-transitory computer readable medium storing thereon computer executable instructions for loading an operating system (OS) driver, including instructions for:
receiving, by a server, at least one version of the OS kernel;
compiling the driver for each version of the OS kernel;
generating a driver template by removing from at least one compiled driver information necessary to load said compiled driver into an OS;
generating a configuration file that includes necessary information to load the driver on at least one version of the OS kernel, wherein the necessary information is extracted from the compiled drivers; and
transmitting, by the server, the driver template and the configuration file to a client;
determining at least one version of the OS kernel installed on the client;
assembling the resulting driver for each determined version of the OS kernel installed on the client based on the configuration file and the driver template; and
loading at least one resulting driver into the OS of the client.

18. The non-transitory computer readable medium of claim 17, wherein the necessary information includes least one of:
a line from the “modinfo” section starting with “vermagic=”;
information from the “version” section;
information from the “this_module” section.

19. The non-transitory computer readable medium of claim 18, wherein the necessary information includes at least one of:
information about the offset of the address of the kallsyms_lookup_name symbol relative to the kmalloc symbol;
information from the “modinfo” section;
information from the section with OS kernel constants;
information from the section with symbols of the OS kernel;
information from the section with driver functions.

20. The non-transitory computer readable medium of claim 17, wherein the generated configuration file comprises all section versions, as well as for each kernel version, comprises the following information:
information from the “modinfo” section starting with “vermagic=”;
section IDs.
